(19) United States
(12) Patent Application Publication
(10) Pub. No.: US 2004/0049986 A1
(43) Pub. Date: Mar. 18, 2004

(54) Automotive side window glass assembly

(76) Inventors: Geoffrey Barr, Troy, MI (US); Gordon L. Cook, Flint, MI (US)

Correspondence Address: Charles K. Veenstra, Delphi Technologies, Inc., P.O. Box 5052, Troy, MI, 48007-5052, US

(21) Appl. No.: 10/245,095

(22) Filed: Sep. 16, 2002

(51) Int. Cl. E05F 11/48

(52) U.S. Cl. 49/352

(57) ABSTRACT

An automotive window glass assembly has a division post carried by a support, a movable window pane that has an edge that slides in a slot of the division post, and a window regulator for raising and lowering the movable window pane. The window regulator includes a forward bracket and a rearward bracket that are spaced apart and secured to a bottom portion of the movable window pane, a set of upper and rollers that are spaced equidistant from the division post for guiding the forward bracket, a guide rail carried by the support in a parallel relationship with the division post, and guiding the rearward bracket, and a drive assembly for raising and lowering the forward bracket and the rearward bracket in unison. The drive assembly includes a movable cable or cables that are attached to the forward bracket and wrapped around the set of upper and lower rollers for travel in a path that is parallel to the division post.

### FIELD OF THE INVENTION

This invention relates to an automotive side window glass assembly and more particularly to an automotive side window glass assembly that includes a window regulator for raising and lowering a movable window glass pane.

### BACKGROUND OF THE INVENTION

U.S. Pat. No. 4,691,475 granted to Junichi Maekawa Sep. 8, 1987 and U.S. Pat. No. 4,607,456 granted to Daiichi Shirasishi Aug. 26, 1986 disclose “dual channel’window regulator systems in which an automotive side window glass is moved up and down by forward and rearward brackets that are secured to the lower portion of the window glass and slide in forward and rearward generally vertical guide channels or rails that are secured to the vehicle body or door. The brackets are moved by a cable or the like that is trained around pulleys at the upper and lower ends of at least one two guide channels in a loop. The cable or its equivalent in turn is driven by a crank arm or an electric motor via a cable drum or drive pulley.

U.S. patent application Ser. No. 10/068,102 filed by Brian H. Staser et al. Feb. 5, 2002 discloses a “dual channel” cable drive window regulator for a window glass of the door that is slideably supported at its forward and rearward ends by doorframe guide portions, which are arranged along the vertical direction of the door. The window regulator has forward and rearward brackets that are secured to the lower end portion of the window glass. The brackets slide on forward and back vertical guide channels that are fixed to the vehicle door between the door frame guide portions. The brackets are secured to a tape or series of tapes that are trained over upper and lower rollers on each vertical guide channel so as to run in a figure eight loop. The tape is driven by a drive roller or cable drum which is driven by an electric motor. Electric motor drives the tape in one direction to raise the window glass and in the opposite direction to lower the window glass.

U.S. patent application Ser. No. 10/056,618, filed by Brian H. Staser et al. Jan. 25, 2002 discloses a roller assembly for window regulators that can be used in either a “single channel” or a “dual channel” window regulator.

Automotive side window glass is usually installed in side doors of the vehicle but can be installed in the vehicle body itself, such as rear windows in two door vehicles. A common problem for a moveable glass side window in a front door installation is interference between the moveable side window glass and the door hinge. A similar problem occurs in rear side window glass installations where there is often interference between the moveable side window glass and the rear wheel well. A common solution to these similar problems in the use of a division post which divides the side window glass into a fixed glass pane and a movable glass pane. A vertical edge of the fixed glass pane is held by one side of the division post and a vertical edge of the moveable glass pane is guided by the opposite side of the division post. These rear side divided window glass installations can be found in rear vehicle doors or in the vehicle body itself. In the case of vehicle doors, the door may be a front door or a rear door and the door may be framed or frameless.

### SUMMARY OF THE INVENTION

This invention provides an economical automotive side window glass assembly having a division post, a moveable window glass pane, and a window regulator for the movable window glass pane in which the division post performs dual functions. These are the normal function of guiding an edge of the moveable side window glass pane and the extraordinary function of guiding a window bracket so as to eliminate the need for one of the guide channels of a “dual channel” window regulator. The automotive side window glass assembly of the invention can be adapted for installation in a front door, a rear door or the automotive vehicle body itself.

An automotive side window glass assembly of the invention has a division post carried by a support, a movable window pane that has an edge that is guided by the division post, and a window regulator for raising and lowering the movable window pane. The window regulator has a forward bracket and a rearward bracket that are spaced apart and secured to a bottom portion of the movable window pane. A set of upper and lower rollers that are spaced equidistant from the division post guide the forward bracket. A guide channel or rail carried by the support in a parallel relationship with the division post guides the rearward bracket, and a drive assembly raises and lowers the forward bracket and the rearward bracket in unison. The drive assembly includes a movable cable or cables that are attached to the forward bracket and wrapped around the set of upper and lower rollers for travel in a path that is parallel to the division post.

### BRIEF DESCRIPTION OF THE DRAWINGS

FIG. 1 is a front view, schematic in nature, of a prior art side window glass assembly that includes a division post and a window regulator;

FIG. 2 is a front view, schematic in nature, of a side window glass assembly of the invention that includes a division post and a window regulator; and

FIG. 3 is a section taken substantially along the line 3-3 of FIG. 2 looking in the direction of the arrows.

### DETAILED DESCRIPTION OF PREFERRED EMBODIMENT

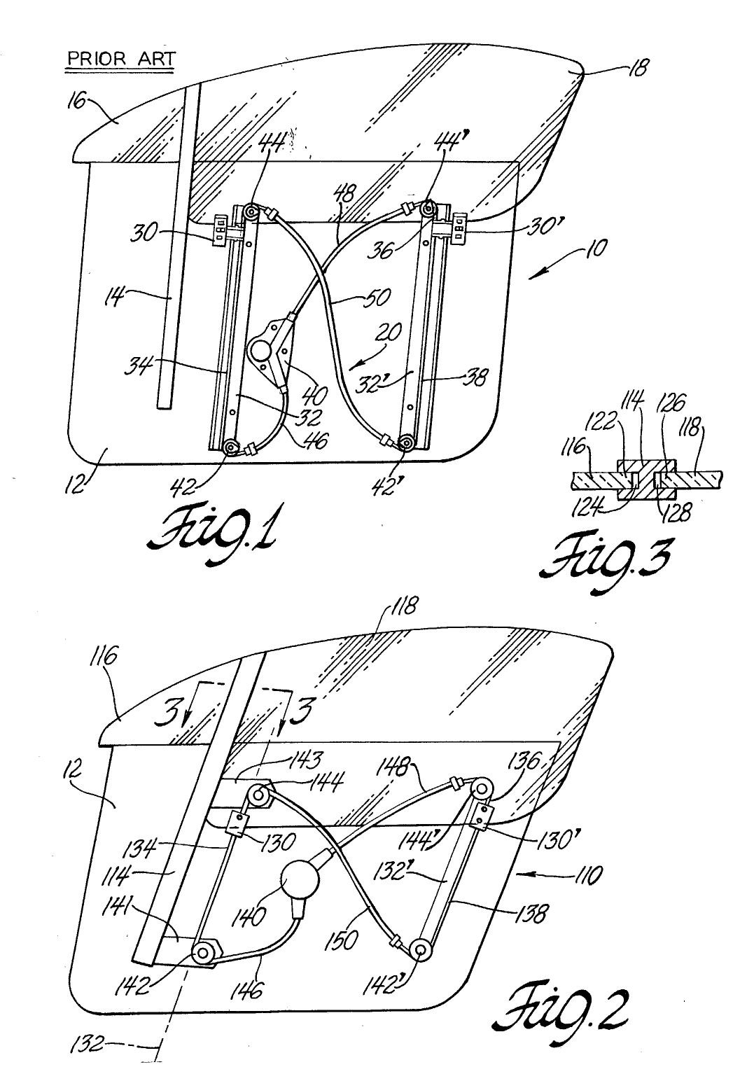

Referring now to FIG. 1, a prior art side window glass assembly for an automotive installation is indicated generally at 10. Assembly 10 comprises a support 12 that carries a division post 14, a fixed glass pane 16, a moveable glass pane 18, and a window regulator 20 for raising and lowering the moveable glass pane 18.

Fixed glass pane 16 has a rear vertical edge that is disposed in a forward channel of division post 14 while moveable glass pane has a forward edge that slides in a rearward channel 28 of division post 14.

Window glass pane 18 is raised and lowered by window regulator 20 that includes forward and rearward bracket assemblies 30, 30′ that are secured to the lower end of the window glass pane 18. Bracket assemblies 30, 30′ run respectively on vertical guide channels 32, 32′ that are mounted on support 12. Bracket assemblies 30, 30′ are moved vertically on guide channels 32, 32′ by cables 34, 36 and 38 that are moved by a cable drum that rotates in a cable drum housing 40 that is attached to support 12. The cable drum is rotated by a crank handle or by an electric motor (not shown). The ends of cables 34 and 36 are attached to the cable drum in cable drum housing 40 so that one cable is wound onto the cable drum while the other cable is simultaneously payed off (wound off) the cable drum with the cable being wound onto the cable drum depending upon the rotation of the cable drum. Such cable drums are well know and need not be described in detail.

Cable 34 wraps around a lower roller 42 at the lower end of forward guide channel 32 and then is attached to forward bracket assembly 30 so as to pull down on bracket assembly 30 when the cable drum is rotated in one direction. On the other hand, cable 36 wraps around an upper roller 44′ at the upper end of rearward guide rail 32′ so as to pull up on rearward bracket assembly 30′ when the cable drum is rotated in the opposite direction. The third cable 38 connects the forward bracket assembly 30 to the rearward bracket assembly 30′ and is trained over an upper roller 44 at the upper end of forward guide channel 32 and a lower roller 42′ at the lower end of rearward guide channel 32′ so that forward bracket assembly 30 pulls rearward bracket assembly 30′ down when forward bracket assembly 30 is pulled down and rearward bracket assembly 30′ pulls forward bracket assembly 30 up when rearward bracket assembly 30′ is pulled up. Cables 34, 36 and 38 are preferably kept in tension. One way to tension cables 34, 36 and 38 is to provide cable jackets or conduits 46, 48 and 50 that are spring biased at each end away from the cable drum housing 40 or associated roller 42, 42′, 44 or 44′. This is a well known technique and need not be described in detail.

Referring now to FIG. 2, the side window glass assembly 110 of the invention comprises a support 112 that carries a division post 114, a fixed glass pane 116, a moveable glass pane 118, and a window regulator 120 for raising and lowering the moveable glass pane 118.

Fixed glass pane 116 has a rear vertical edge 122 that is disposed in a forward channel 124 of division post 114 while moveable glass pane 118 has a forward edge 126 that slides in a rearward channel 128 of division post 114 as best shown in FIG. 3.

Window glass pane 118 is raised and lowered by window regulator 120 that includes forward and rearward bracket assemblies 130, 130′ that are secured to the lower end of the window glass pane 118.

The front guide channel of the prior art arrangement described above in connection with FIG. 1 has been eliminated so that forward bracket assembly 130 does not run on any guide channel or rail. However, the forward bracket assembly 130 is guided along a path line 132 that is parallel to division post 114 by cables 134 and 138 that run bracket assembly 130 between an upper roller 144 and a lower roller 142 that are located equidistant from division post 114. Upper roller 144 is supported by a bracket 143 that is attached to the upper portion of division post 144. Lower roller 142 is supported by a bracket 141 that is attached to the lower portion of division post 114.

Bracket assembly 130′ runs on vertical guide channel 132′ that is mounted on support 12. Bracket assemblies 130, 130′ are moved vertically by cables 134, 136 and 38 that are moved by a cable drum that rotates in a cable drum housing 140 that is attached to support 12. The cable drum is rotated by a crank handle or by an electric motor (not shown). The ends of cables 134 and 136 are attached to the cable drum in cable drum housing 140 so that one cable is wound onto the cable drum while the other cable is simultaneously payed off (wound off) the cable drum with the cable being wound onto the cable drum depending upon the rotation of the cable drum. Such cable drums are well known and need not be described in detail.

Cable 134 wraps around a lower roller 142 that is supported by bracket 141 that is attached to the lower end of division post 114 and cable 134 is then attached to forward bracket assembly 130 so as to pull down on bracket assembly 130 when the cable drum is rotated in one direction. On the other hand, cable 136 wraps around an upper roller 144′ at the upper end of rearward guide channel 132′ so as to pull up on rearward bracket assembly 130′ when the cable drum is rotated in the opposite direction. The third cable 138 connects the forward bracket assembly 130 to the rearward bracket assembly 130′ and is trained over an upper roller 144 that is supported by bracket 143 and a lower roller 142′ at the lower end of rearward guide channel 132′ so that forward bracket assembly 130 pulls rearward bracket assembly 130′ down when forward bracket assembly 130 is pulled down and rearward bracket assembly 130′ pulls forward bracket assembly 130 up when rearward bracket assembly 130′ is pulled up. Cables 134, 136 and 138 are preferably kept in tension. One way to tension cables 134, 136 and 138 is to provide cable jackets or conduits 146, 148 and 150 that are spring biased at each end away from the drum housing 140 and the associated rollers assembly 142, 144, 142′, 144′. This is a well known technique and need not be described in detail.

Suitable bracket assemblies 130 and 130′ are described in detail in U.S. patent application Ser. No. 10/068,102 discussed above. Upper and lower rollers 42, 42′, 44 and 44′ may be provided as part of the roller assemblies that are described in detail in copending U.S. patent application Ser. No. 10/056,618 that is discussed above. However, these bracket assemblies and roller assemblies need not be described in detail to understand the invention. Any suitable bracket and roller assembly can be used.

Cables 134, 136 and 138 form a figure eight loop that begins and ends at the cable drum in cable drum housing 140. While three distinct cables are shown, it is possible to have one cable that is attached at one end to the cable drum then proceeds to an attachment at forward bracket assembly 130 then proceeds to an attachment at rearward bracket assembly 130′ and then proceeds to an attachment at the opposite end of the cable drum. Moreover, it is also possible to use an endless cable in which case the cable drum is replaced by a drive pulley that drives the endless cable in the forward and reverse directions. Of course if a single cable or a single endless cable is used, some means to keep the cable in tension would preferably be provided as in the case of the three separate cables 134, 136 and 138 that are shown in FIG. 2.

Moreover, it is also possible to eliminate the drive to the rearward bracket assembly 130′ in some instances and simply guide the rearward bracket assembly 130′ by channel 132′. In this case, cable 138 would be connected directly to the cable drum in cable drum housing 140. Furthermore, cables 134 and 138 in this configuration can be single cable or a single endless cable.

In other words, while a preferred embodiment is disclosed, a worker in this art would understand that various modifications would come within the scope of the invention. Thus, the following claims should be studied to determine the true scope and content of this invention.

We claim:

1. An automotive window glass assembly, comprising:
a support,
a division post carried by the support,
a movable glass pane having an edge that is guided by the division post, and a window regulator for raising and lowering the movable glass pane,
the window regulator including a forward bracket and a rearward bracket that are spaced apart and secured to a bottom portion of the movable glass pane,
a set of upper and lower rollers that are spaced equidistant from the division post for guiding the forward bracket,
a guide channel carried by the support in a parallel relationship with the division post, and guiding the rearward bracket, and
a drive assembly for raising and lowering the forward bracket, the drive assembly including a movable cable or cables that are attached to the forward bracket and wrapped around the upper and lower rollers for travel in a path that is parallel to the division post.

2. The automotive window glass assembly as defined in claim 1 wherein the movable cable or cables are in a figure eight configuration and wrapped around a second set of upper and lower rollers that are attached to the guide channel.

3. The automotive window glass assembly as defined in claim 1 wherein the drive assembly includes only one movable cable.

4. The automotive window glass assembly as defined in claim 1 wherein the drive assembly includes a first moveable cable that is attached to the forward bracket and that is wrapped around a lower roller of the set of upper and lower rollers and a second moveable cable that is attached to the forward bracket and that is wrapped around an upper roller of the set of upper and lower rollers.

5. The automotive window glass assembly as defined in claim 2 wherein the drive assembly includes only one movable cable.

6. The automotive window glass assembly as defined in claim 2 wherein the drive assembly includes a first moveable cable that is attached to the forward bracket and that is wrapped around a lower roller of the set of upper and lower rollers and a second moveable cable that is attached to the forward bracket and that is wrapped around an upper roller of the set of upper and lower rollers.

7. The automotive window glass assembly of claim 6 wherein the second moveable cable is wrapped around a lower roller of the second set of upper and lower rollers and attached to the rearward bracket, and wherein the drive assembly includes a third moveable cable that is attached to the rearward bracket and that is wrapped around an upper roller of the second set of upper and lower rollers.

8. An automotive window glass assembly, comprising:
a support,
a division post carried by the support,
a movable glass pane having an edge that slides in a slot of the division post, and
a window regulator for raising and lowering the movable glass pane,
the window regulator including a forward bracket and a rearward bracket that are spaced apart and secured to a bottom portion of the movable glass pane,
a first set of upper and lower rollers that are spaced equidistant from the division post by brackets attached to the division post for guiding the forward bracket,
a guide channel carried by the support in a parallel relationship with the division post, and guiding the rearward bracket, and
a drive assembly for raising and lowering the forward bracket and the rearward bracket in unison,
the drive assembly including at least one movable cable that is attached to the forward bracket and that travels in a path that is parallel to the division post.

9. An automotive window glass assembly, comprising:
a support,
a division post carried by the support,
a fixed glass pane on one side of the division post,
a movable glass pane on an opposite side of the division post, the movable glass pane having an edge that slides in a groove of the division post, and
a window regulator for raising and lowering the movable glass pane,
the window regulator including a forward bracket and a rearward bracket that are spaced apart and secured to a bottom portion of the movable window pane,
a first set of upper and lower rollers that are supported by upper and lower brackets respectively and spaced equidistant from the division post for guiding the forward bracket,
a guide channel carried by the support in a parallel relationship with the division post, and guiding the rearward bracket, and
a drive assembly for raising and lowering the forward bracket and the rearward bracket in unison,
the drive assembly having a movable cable or cables that are wrapped around the first and second sets of upper and lower rollers in a figure eight configuration,
the movable cable or cables including at least one movable cable that is attached to the forward bracket and that travels in a path that is parallel to the division post, the at least one movable cable being wrapped around at least one of the upper and lower rollers of the first set of upper and lower rollers for travel in the path that is parallel to the division post.
